(19) United States
(12) Patent Application Publication
(10) Pub. No.: US 2008/0232778 A1
(43) Pub. Date: Sep. 25, 2008

(54) Method and system for media production in virtual studio

(76) Inventors: San Wei Lin, Luodong Township (TW); Hsiao Chung Chou, Yonghe City (TW); Chih-Mao Lin, Keelung City (TW); Chen-Hsiu Weng, Jhonghe City (TW); Yon-Fon Kuo, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/826,842

(22) Filed: Jul. 19, 2007

(30) Foreign Application Priority Data
Mar. 22, 2007 (CN) 200720005940.5

(51) Int. Cl. H04N 5/00

(52) U.S. Cl. 386/117; 386/E05.001

(57) ABSTRACT

A media production system for a virtual studio includes a storage unit to store multiple lots of AV data, a shooting unit to retrieve continuous AV data of a shooting object without relying upon any straight color screen to retrieve the shooting object and the screen in straight color, an image composition unit to automatically compose those continuous AV data and a lot of target AV data to create and automatically store in the storage unit a lot of audio data and a virtual picture adapted to the lot of audio data, and an output unit to output audio data and virtual picture.

### BACKGROUND OF THE INVENTION

(a) Field of the Invention

The present invention is related to a method and a system for media production in a virtual studio, and more particularly, to an automation and interaction media production system for a 3D virtual studio.

(b) Description of the Prior Art

Usually, a work team for a general virtual studio is about the same size as that for a conventional film studio. It takes director, program director, technical director, cameraman, light engineer, props master, animator, virtual studio operator and system maintenance crew for operation of the virtual studio. Before producing a program, it requires well-planned script and rehearsal involved by all team members. The shooting for the entire program is somehow quite a project since it remains requiring the involvement of all the production team even though costs of scenario setup and swift time and money are saved.

Accordingly, what is need is a virtual studio that allows easy operation at low cost and improves the ways of media production to save a lot of workforce and reduce difficulties encountered in the production of a program and even to make the media production a personal entertainment.

### SUMMARY OF THE INVENTION

The primary purpose of the present invention is to provide an automated media production system for a 3D virtual studio. To achieve the purpose, preparations including story of the film, animated virtual images and music are completed before taping. Then HW/SW facilities needed in the taping are set up using the media production system for a virtual studio of the present invention. It takes only a person to playback the contents to be shoot and start up facilities in the course of taping to immediately access to the shooting results upon completing the taping without the necessities of postproduction and editing.

Another purpose of the present invention is to provide an interaction media production system for a 3D virtual studio. To achieve the purpose, a leading character, i.e., a shooting object, is viewed as an animated virtual image on a monitor in the taping process; meanwhile, the shooting object develops interaction with the animated virtual image and the results of interaction is real-time displayed on the monitor to make the picture even life, spectacular and enriched.

The object of the present invention relates to a summary media production system for a virtual studio, and it is similar to the relation between a PC to a very large computer. The present invention while retaining most functions of a virtual studio generally available provides advantages of low cost and minimum location limitation. It provides a popular platform. That is, a standardized 3D virtual studio defines a production standard for the design of the contents. The platform is applicable to any contents meeting this standard or any customized contents with an application range covering pre-school teaching, entertainment, music film, personal traveling notes, personal special collection, wedding photography, simulation training, on stage with idol stars, animation games, etc. Furthermore, the present invention by permitting low cost and high mobility of HW erection is accessible by general public at any time and any place including scenic spots, department stores, supermarkets, malls, topic amusement parks, academic institutes, etc.

### BRIEF DESCRIPTION OF THE DRAWINGS

FIG. 1 is a block chart showing the present invention; and

FIG. 2 is a flow path of the present invention.

### DETAILED DESCRIPTION OF THE PREFERRED EMBODIMENTS

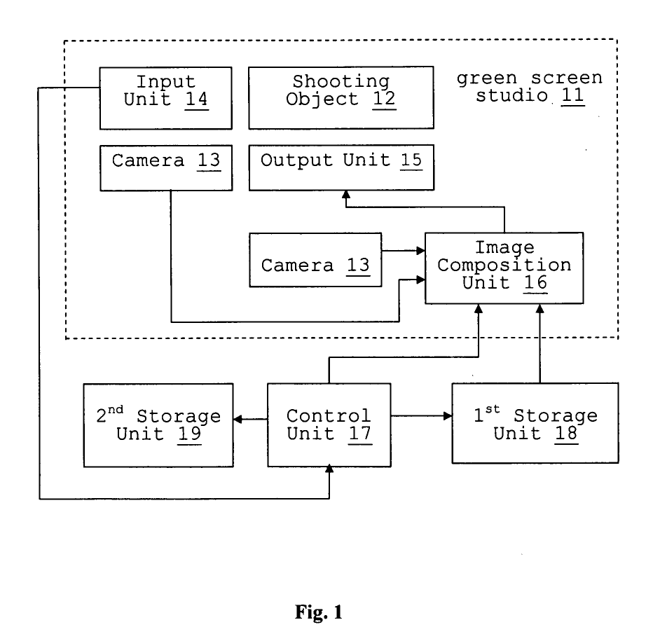

Referring to FIG. 1 for a block chart of the present invention, a system for media production in a virtual studio of the present invention includes a green screen studio 11, a shooting object 12, multiple units of camera 13, an input unit 14, an output unit 15, an image composition unit 16, a control unit, a first storage unit 18, and a second storage unit 19. Wherein, the green screen studio 11 relates to a monochromatic film studio, and its background screen is commonly in blue or green to facilitate masking background in a process of image composition. Of course, the shooting can be done without the background screen. Because media production system does not need extra operator, the size of the green screen studio 11 is naturally smaller than that of a conventional one. Therefore, the green screen studio 11 will not consume too much space. Secondary, the shooting object 12 moving about in the green screen studio 11 is usually related to one or a plurality of person or animal. Multiple cameras 13 are needed to simultaneously or alternatively retrieve data of continuous images of the shooting object 12 in different angle and transmitting the retrieved data to the image composition unit 16. The input unit 14, e.g., a keyboard or a touch screen is connected to the control unit 17 for providing the shooting object 12 to select a target AV data which the shooting object 12 needs. The target AV data generally can include an object image data, a virtual AV data, and an audio data; and the object image data or the virtual image data can be used as a foreground and background, and a virtual foreground or virtual background so created can have interaction with the shooting object 12 in a virtual picture. The output unit 15, e.g., a liquid crystal display, a plasma TV or a CRT display and speaker is connected to the image composition unit 16 to display and playback the interaction taken place between the shooting object 12 and the virtual foreground or background. The image composition unit 16 receives those continuous image data of the shooting object 12 transmitted from the camera units 13 and the target image data transmitted from the first storage unit 18 to process real-time background masking and image composition, and then outputs the processed data to the output unit 15.

Subsequently, the control unit 17, e.g., a PC, accesses data in the first storage unit 18 and the second storage unit 19, and receives and processes commands from the input unit 14, and controls parameter related to image process in the image composition unit 16. The control unit 17 can also adjust or replace composition data which already display and played back according to the interaction between the target AV data and the shooting object 12. The control unit 17 is also capable of automatically switching among multiple cameras to retrieve the images of the shooting object 12. The control unit 17 equipped with standard equipment including processor, hard disk, and motherboard of a PC is further adapted with or connected to the first storage unit 18. In a preferred embodiment of the present invention, any necessary AV data, e.g., music, songs, virtual space, background, foreground, or characters are stored in the first storage unit before the shooting and properly classified and tagged. For example, lyrics or music of a song are provided with corresponding virtual space, background, foreground or character(s), and accompanying image or a segment of music for a particular scenario that are categorized for subsequent process of composition. The first storage unit 18, e.g., a PC hard disk, a DVD CD-ROM drive with CD, can be incorporated with the control unit 17. The image composition unit 16 can translate a physical position of the shooting object 12 on the green screen studio 11 into that in the virtual space in real time for composing those continuous AV data of the shooing object 12 and the image composition unit 16 stored in the first storage unit 18 to create a virtual picture. The image composition unit 16 then outputs the virtual picture to the output unit 15.

Furthermore, the preferred embodiment of the present invention provides virtual picture of real-time interaction. That is, the shooting object 12 can view its relative positions with the virtual objects on the virtual picture on the output unit 15 in a real time and select a virtual object including foreground or background for interaction with the selected virtual object. For example, when the virtual picture incorporated with those continuous image data of the shooting object is displayed on the output unit 15, e.g., multiple doors in different colors for the shooting object 12 to select a door to enter, if the shooting object 12 want to enter a red door, he/she can move towards a corresponding position of virtual red door on the screen in the green screen studio and push the door forward. Though there is no such a red substantial door in the green screen studio 11, the door is actually pushed to open by the shooting object 12 when viewed on the screen. The control unit 17 then will select another AV data from the first storage unit 18 and output the selected AV data to the output unit 15. Soonest, the shooting object 12 is able to view changes of the foreground, the background, the virtual character on the screen of the output unit 15, or audio data, e.g., song or music, to show a totally different view behind the door. Accordingly, with the minimum workforce, incorporation with the contents of the virtual picture to create interaction with the shooting object 12 adds more fun to the contents of the virtual picture. Finally, the entire process is outputted to the second storage unit 19 for storing in a medium, e.g., output to a DVD burner and storage in a CD.

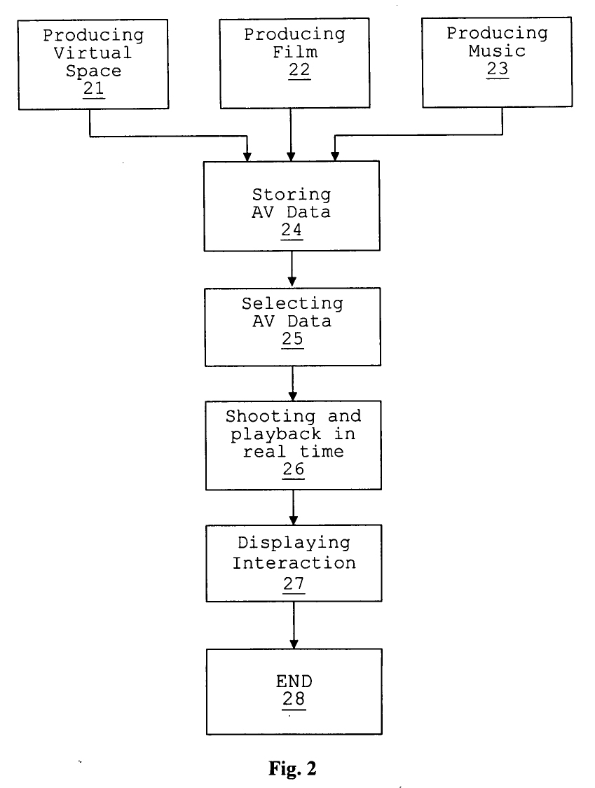

Now referring to FIG. 2 for a flow path in production of interactive virtual picture using the system of the present invention, the flow path corresponds to the block chart illustrated in FIG. 1 and includes the following steps of:

Step 21: Producing a virtual space.

Step 22: Taping a film.

Step 23: Producing music.

wherein, Step 21, Step 22 and Step 23 are executed simultaneously.

Step 24: Storing AV data. The AV data which includes either real or virtual image or audio data is stored in the first storage unit 18. For example, a real bird's view image or a song taped, or virtual image or audio data originated from digital production to present an animated background or composition music. All these AV data can be pre-analyzed and the analyzed characteristics is stored in a storage unit. For example, songs characterized in features of landscape scenario or fast beat are categorized into multiple types, or multiple A/V groups are prearranged.

Step 25: Selecting AV data. The shooting object 12 can use the input unit to select an AV data from those stored in the first storage unit 18 as the target AV data to playback.

Step 26: Shooting and playing back continuous image data of the shooting object 12 in real time. First the camera 13 retrieves action of the shooting object 12 and transmits the image taken to the image composition unit 16. The image composition unit 16 then calculates and analyzes the relative position in the virtual space of the shooting object 12, and incorporates image data of the shooting object 12 with the AV data taken from the first storage unit 18, and outputs the incorporate AV data to the output unit 15 for real-time playback. In a preferred embodiment, the shooting object 12 can pre-select a desired song and the control unit searches multiple AV data corresponding to the selected song in the first storage unit 18. It becomes apparent that since the shooting is all done in the green screen studio 11, routines of masking and composition of virtual pictures can be done in the image composition unit 16 in real time. Furthermore, whereas the present invention automatically analyzes AV data of the shooting object 12, no professional of virtual studio other than the shooting object is needed to execute production of virtual picture thus for the present invention to achieve the purpose of easy operation.

Step 27: Displaying interaction on the output unit 15. The shooting object 12 can appreciate the virtual picture and music on the output unit 15 in real time. In a preferred embodiment, the shooting object 12 can interact with the virtual picture to created changed foreground, background, or music. The image composition unit 16 composes various virtual pictures and audios and outputs the AV compositions to the output unit 15 according to interaction between the shooting object 12 and virtual images. The shooting object 12 can enjoy interests brought in by the virtual picture; and

Step 28: End. Finally, virtual AV pictures displayed and played back are immediate are immediately stored into a CD for future view.

Accordingly, the present invention provides a virtual studio to produce interaction virtual pictures, and the virtual studio relies upon only a green screen film with adequate space and simple shooting to easily produce interaction virtual pictures at professional level. The virtual studio is very ideal for personal taping and application.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A system for media production in a virtual studio comprising:
a storage unit, for storing multiple AV data;
a camera unit, for retrieving continuous image data of a shooting object, and no screen in any pure color being needed behind the shooting object to shoot the shooting object and the screen in that color;
an image composition unit, for automatically composing those continuous image data and a target AV data selected from those continuous image data to create a audio data and a virtual picture adapted to that lot of audio data, the audio data and the virtual picture being automatically stored in the store unit; and
an output unit, for outputting the audio data and the virtual picture.

2. The system as claimed in claim 1, further comprising an input unit for providing multiple options for the shooting object.

3. The system as claimed in claim 2, wherein those options include those AV data.

4. The system as claimed in claim 1, wherein the camera unit includes multiple sets of camera which can automatically switch among themselves for retrieving those continuous image data.

5. The system as claimed in claim 1, wherein the shooting object moves about in a green screen studio.

6. The system as claimed in claim 1, wherein the shooting object creates interaction with a target image data selected from the target AV data.

7. The system as claimed in claim 6, wherein the interaction includes changing the target AV data according to a virtual objected selected from the target image data.

8. The system as claimed in claim 1, wherein the virtual picture includes a foreground or a background from a target image data of the target AV data.

9. The system as claimed in claim 8, wherein the target image data include an object image data or a virtual image data.

10. A system for media production in a virtual studio comprising:
a green screen studio, as a film studio for retrieving continuous image data;
an input unit, for providing multiple options;
a first storage unit, for storing multiple AV data;
a second storage unit for storing a lot of audio data and a virtual picture;
a shooting unit, including multiple sets of camera for retrieving continuous image data of a shooting object;
an image composition unit, connected to those cameras, for composing the continuous image data and a lot of target image data selected from those AV data to create the virtual picture;
an output unit, connected to the image composition unit, for playing back the virtual picture and those audio data adapted to the virtual picture; and
a control unit, connected to the first storage unit, the second storage unit, the image composition unit and the input unit, for controlling and accessing those AV data stored in the first storage unit, and for storing those audio data and the virtual picture in the second storage unit, and for controlling the image composition unit and the input unit.

11. The system as claimed in claim 10, wherein the green screen studio includes a blue screen or a green screen.

12. The system for as claimed in claim 10, wherein the output unit is connected to the first storage unit.

13. The system for as claimed in claim 10, wherein the control unit further switches those cameras.

14. The system for as claimed in claim 10, wherein the control unit further controls the output unit to playback the virtual picture and those audio data in real time and store them in the second storage unit.
